(19) United States
(12) Patent Application Publication
(10) Pub. No.: US 2017/0220761 A1
(43) Pub. Date: Aug. 3, 2017

(54) SYSTEM, METHOD, AND NON-TRANSITORY COMPUTER-READABLE STORAGE MEDIA FOR GENERATING DATA FOR USE IN COMPUTER SYSTEMS

(71) Applicant: Wal-Mart Stores, Inc., Bentonville, AR (US)

(72) Inventors: Justin Toupin, San Francisco, CA (US); Nathan Thomas Diepenbrock, Highlands Ranch, CO (US)

(21) Appl. No.: 15/009,417

(22) Filed: Jan. 28, 2016

(51) Int. Cl. G06F 19/00

(52) U.S. Cl. CPC G06F 19/3456; G06F 19/322

(57) ABSTRACT

A networked computer system for generating pharmaceutical data for use by a 3^{rd} party entity server system is described herein. The networked computer system includes a server computer and a database. The database includes a list of user pharmacy account records and a list of authenticated entity records. The server computer receives a request to transmit a pharmacy record to an entity server system and initiates a verification operation to verify an identity of the entity server system. The server computer accesses the list of user pharmacy account records upon verifying the identity of the entity server system, selects a user pharmacy account record associated with a received user ID, generates a pharmacy data record as a function of the selected user pharmacy account record, and transmits the generated pharmacy data record to the entity server system.

### COPYRIGHT NOTICE

The figures included herein contain material that is subject to copyright protection. The copyright owner has no objection to the facsimile reproduction by anyone of this patent document as it appears in the U.S. Patent and Trademark Office, patent file or records, but reserves all copyrights whatsoever in the subject matter presented herein.

### FIELD OF THE DISCLOSURE

U.S. Patent Classification Primary Class: 707 (DATA PROCESSING: DATABASE, DATA MINING, AND FILE MANAGEMENT OR DATA STRUCTURES). Art Unit: 2161.

The present invention relates to providing product information to a consumer, and more particularly, to systems, methods, and computer-readable storage media that monitor activities of pharmacy customers, generates data associated with the monitored activities, and generates pharmacy data records that may be transmitted to authenticated 3^{rd} party computer systems.

### BACKGROUND

Many pharmacy consumers desire to obtain services related to their general heath and the pharmaceutical medications being prescribed to them remotely, e.g., on-line, through the Internet, or using a specially designed application or app on a personal computer or mobile device, such as a tablet or cell phone. In addition, pharmacy customers desire to have services that facilitate their adherence to medication schedules and improve general health monitoring.

At least some known computer systems provide computer applications that collect and analyze health related information provided by the user. However, these known systems require data associated with current prescription medications to be entered manually by the user. Requiring a user to manually enter information into these known systems may result in errors in the data being provided. In addition, many pharmacy consumers are unable to verify if these health related computer systems are in compliance with the Health Insurance Portability and Accountability Act (HIPPA) and are provide sufficient security and encryption of their information. Furthermore, because of the increasing number of pharmaceutical drugs being made available to consumers and the amount of drug information associated with the pharmaceutical drugs, users may become frustrated with the amount of information that must be manually entered into these known systems. Moreover, as the amount of records being included in a database increases, the amount of computing resources that are required to maintain these records and perform related services increase, thus reducing the overall performance of these systems. In addition, because these known systems also require the user to periodically update the information, over time the information related to the user becomes outdated and irrelevant, thus reducing the overall benefit of services being provided to the user.

The present invention is aimed at one or more of the problems identified above.

### SUMMARY OF THE INVENTION

In different embodiments of the present invention, systems, methods, and computer-readable storage media for generating and displaying information to users via mobile computing devices.

In one embodiment of the present invention, a networked computer system for generating pharmaceutical data for use by a 3^{rd} party entity server system is provided. The networked computer system includes a server computer including a processor coupled to a memory device, and a database. The database includes a list of user pharmacy account records and a list of authenticated entity records. Each user pharmaceutical account record includes a pharmacy user ID associated with a pharmacy customer and pharmaceutical drug information associated with corresponding prescription drug medications. Each authenticated entity record includes a unique entity ID and corresponding authentication data. The server computer is programmed to receive a request to transmit a pharmacy record to an entity server system including an entity ID associated with the entity server system and a user ID associated with a pharmacy customer. The server computer initiates a verification operation to verify an identity of the entity server system upon receiving the request including accessing the list of authenticated entity records and determining an authenticated entity record having an entity ID matching the received entity ID. The server computer accesses the list of user pharmacy account records upon verifying the identity of the entity server system, selects a user pharmacy account record associated with the received user ID, generates a pharmacy data record as a function of the selected user pharmacy account record, and transmits the generated pharmacy data record to the entity server system.

In another embodiment of the present invention, a computer-implemented method of operating a networked computer system for generating pharmaceutical data for use by a 3^{rd} party entity server computer is provided. The networked computer system includes a database and a server computer including a processor coupled to a memory device. The method includes the steps of the server computer receiving a request to transmit a pharmacy record to an entity server computer and accessing the database including a list of user pharmacy account records and a list of authenticated entity records. Each user pharmaceutical account record includes a pharmacy user ID associated with a pharmacy customer and pharmaceutical drug information associated with corresponding prescription drug medications. Each authenticated entity record includes a unique entity ID and corresponding authentication data. The request includes an entity ID associated with the entity server computer and a user ID associated with a pharmacy customer. The server computer initiates a verification operation to verify an identity of the entity server computer upon receiving the request to transmit a pharmacy record including accessing the list of authenticated entity records and determining an authenticated entity record having an entity ID matching the received entity ID. The server computer accesses the list of user pharmacy account records upon verifying the identity of the entity server computer, selects a user pharmacy account record associated with the received user ID, generates a pharmacy data record as a function of the selected user pharmacy account record, and transmits the generated pharmacy data record to the entity server computer.

In yet another embodiment, one or more non-transitory computer-readable storage media, having computer-executable instructions embodied thereon are provided. When executed by at least one processor, the computer-executable instructions cause the processor to receive a request to transmit a pharmacy record to an entity server computer and access a database including a list of user pharmacy account records and a list of authenticated entity records. Each user pharmaceutical account record includes a pharmacy user ID associated with a pharmacy customer and pharmaceutical drug information associated with corresponding prescription drug medications. Each authenticated entity record includes a unique entity ID and corresponding authentication data. The request includes an entity ID associated with the entity server computer and a user ID associated with a pharmacy customer. The processor initiates a verification operation to verify an identity of the entity server computer upon receiving the request to transmit a pharmacy record including accessing the list of authenticated entity records and determining an authenticated entity record having an entity ID matching the received entity ID. The processor accesses the list of user pharmacy account records upon verifying the identity of the entity server computer, selects a user pharmacy account record associated with the received user ID, generates a pharmacy data record as a function of the selected user pharmacy account record; and transmits the generated pharmacy data record to the entity server computer.

### BRIEF DESCRIPTION OF THE FIGURES

Non-limiting and non-exhaustive embodiments of the present invention are described with reference to the following figures. Other advantages of the present disclosure will be readily appreciated, as the same becomes better understood by reference to the following detailed description when considered in connection with the accompanying drawings wherein:

FIG. 1 is a schematic illustrating various aspects of a system, according to the present invention;

FIG. 2 is a schematic illustrating example components of a server computer that may be used with the system shown in FIG. 1, according to an embodiment of the present invention;

FIGS. 3-4 are flowcharts of methods that may be used with the system shown in FIG. 1, according to embodiments of the present invention;

FIGS. 5-8 are illustrations of exemplary database records generated by the system of FIG. 1, according to embodiments of the present invention; and

FIGS. 9-16 are illustrations of exemplary screenshots from the system of FIG. 1, according to an embodiment of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible media of expression having computer-usable program code embodied in the media.

Any combination of one or more computer-usable or computer-readable media (or medium) may be utilized. For example, a computer-readable media may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart and/or block diagram block or blocks.

Several (or different) elements discussed below, and/or claimed, are described as being “coupled”, “in communication with”, or “configured to be in communication with”. This terminology is intended to be non-limiting, and where appropriate, be interpreted to include without limitation, wired and wireless communication using any one or a plurality of a suitable protocols, as well as communication methods that are constantly maintained, are made on a periodic basis, and/or made or initiated on an as needed basis. The term “coupled” means any suitable communications link, including but not limited to the Internet, a LAN, a cellular network, or any suitable communications link. The communications link may include one or more of a wired and wireless connection and may be always connected, connected on a periodic basis, and/or connected on an as needed basis.

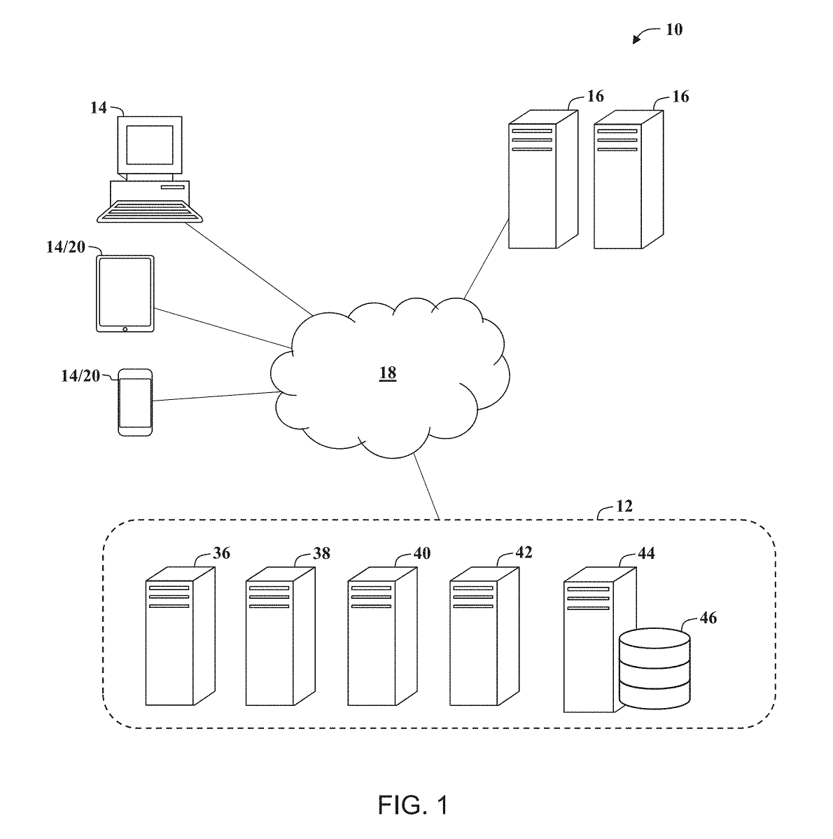

With reference to the FIGS. and in operation, the present invention provides a networked computer system 10, methods and computer product media that monitors the activities of pharmacy customers and generates pharmacy data records for use by 3^{rd} party entities to provide value-added services to pharmacy customers. Referring to FIG. 1, an exemplary environment in which the networked computer system 10 operates is illustrated. In general, the present invention describes a networked computer system 10 that monitors activities of pharmacy customers and generates and stores information associated with prescribed pharmaceutical medications being used by pharmacy customers. The system 10 allows pharmacy customers to share data (purchases, refill adherence, etc.) collected within the system with family members, doctors, insurance providers, etc. For example, in one embodiment, the system 10 allows pharmacy customer to share aggregate purchase data (e.g., micronutrient breakdown) with their doctor along with an adherence record. The system 10 is also programmed to allow pharmacy customers to identity the type of pharmacy information that may be provided to the 3^{rd} party entities, and generate and transmit pharmacy data to customer identified 3^{rd} party entities. In addition, the system is programmed to authenticate the identity of 3^{rd} party computer systems requesting pharmacy customer information and to generate encrypted messaging files that include pharmacy customer data.

By generating user pharmacy account records that include data indicating information that may be provided to 3^{rd} party entities, and allowing users to select the type and amount of pharmacy customer information that may be provided, the system improves the speed and functionality of known computing systems by reducing the amount of computing time required to monitor customer activity and generate data records being transmitted to value added entities, thus reducing the computing resources required to generate and maintain pharmacy customer records.

For clarity in discussing the various functions of the system 10, multiple computers and/or servers are discussed as performing different functions. These different computers (or servers) may, however, be implemented in multiple different ways such as modules within a single computer, as nodes of a computer system, etc. . . . The functions performed by the system 10 (or nodes or modules) may be centralized or distributed in any suitable manner across the system 10 and its components, regardless of the location of specific hardware. Furthermore, specific components of the system 10 may be referenced using functional terminology in their names. The function terminology is used solely for purposes of naming convention and to distinguish one element from another in the following discussion. Unless otherwise specified, the name of an element conveys no specific functionality to the element or component.

Other features of the system 10 can be found in the following commonly owned US Patent Applications, which are hereby incorporated by reference: U.S. patent application Ser. No. N/A, filed on Jan. 28, 2016 (Attorney Docket Number 068571.00242); U.S. patent application Ser. No. N/A, filed on Jan. 28, 2016 (Attorney Docket Number 068571.00243); U.S. patent application Ser. No. N/A, filed on Jan. 28, 2016 (Attorney Docket Number 068571.00245); U.S. patent application Ser. No. N/A, filed on Jan. 28, 2016 (Attorney Docket Number 068571.00246); U.S. patent application Ser. No. N/A, filed on Jan. 28, 2016 (Attorney Docket Number 068571.00247); U.S. patent application Ser. No. N/A, filed on Jan. 28, 2016 (Attorney Docket Number 068571.00248); U.S. patent application Ser. No. N/A, filed on Jan. 28, 2016 (Attorney Docket Number 068571.00249); U.S. patent application Ser. No. N/A, filed on Jan. 28, 2016 (Attorney Docket Number 068571.00250); U.S. patent application Ser. No. N/A, filed on Jan. 28, 2016 (Attorney Docket Number 068571.00251); U.S. patent application Ser. No. N/A, filed on Jan. 28, 2016 (Attorney Docket Number 068571.00252); and, U.S. patent application Ser. No. N/A, filed on Jan. 28, 2016 (Attorney Docket Number 068571.00253).

In the illustrated embodiment, the system 10 includes a server system 12 that is coupled in communication with one or more user computing devices 14 and one or more 3^{rd} party entity server systems 16 via a communications network 18. The communications network 18 may be any suitable connection, including the Internet, file transfer protocol (FTP), an Intranet, LAN, a virtual private network (VPN), cellular networks, etc. . . . , and may utilize any suitable or combination of technologies including, but not limited to wired and wireless connections, always on connections, connections made periodically, and connections made as needed.

The user computing device 14 may include any suitable device that enables a user to access and communicate with the system 10 including sending and/or receiving information to and from the system 10 and displaying information received from the system 10 to a user. For example, in one embodiment, the user computing device 14 may include, but is not limited to, a desktop computer, a laptop or notebook computer, a tablet computer, smartphone/tablet computer hybrid, a personal data assistant, a handheld mobile device including a cellular telephone, and the like. The user computing device 14, as well as any other connected computer systems and their components included in the system 10, can create message related data and exchange message related data (e.g., near field communication (“NFC”) payloads, Bluetooth packets, Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

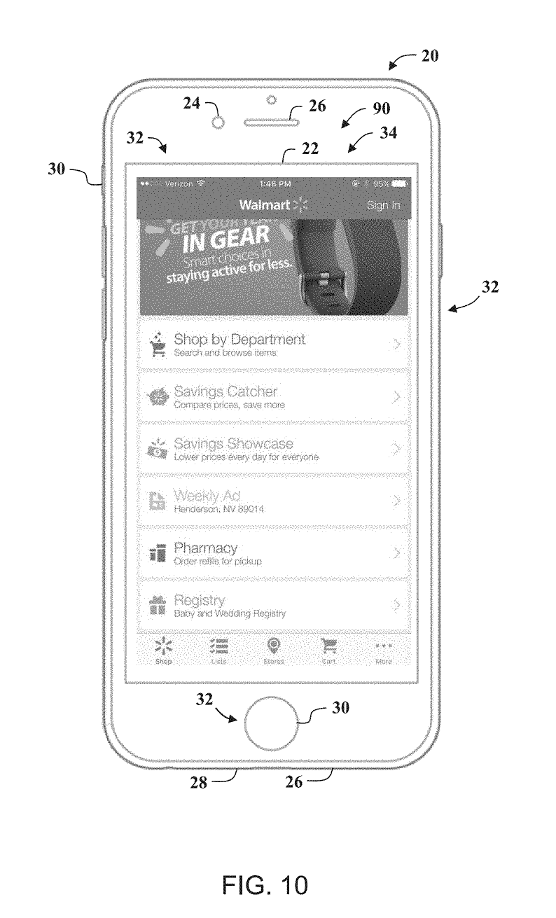

In one embodiment, the user computing device includes a mobile computing device 20 (shown in FIG. 10) such as, for example, a smartphone such as an iPhone™. The mobile computing device 20 includes a processor coupled to a memory device, and a database for storing various programs and data for use in operating the mobile computing device 20. The mobile computing device 20 may also include a touchscreen display device 22, one or more video image cameras 24, one or more speakers 26, a microphone 28, at least one input button 30, and one or more sensors 32 including, but not limited to, a touch ID fingerprint sensor coupled to an input button 30, a barometer, a three-axis gyro, an accelerometer, proximity sensor, and an ambient light sensor. In addition, the mobile computing device 20 may also include a Wi-Fi antenna, a cellular network antenna, a Bluetooth™ communications device, assisted GPS and GLONASS, a digital compass, and an iBeacon microlocation device.

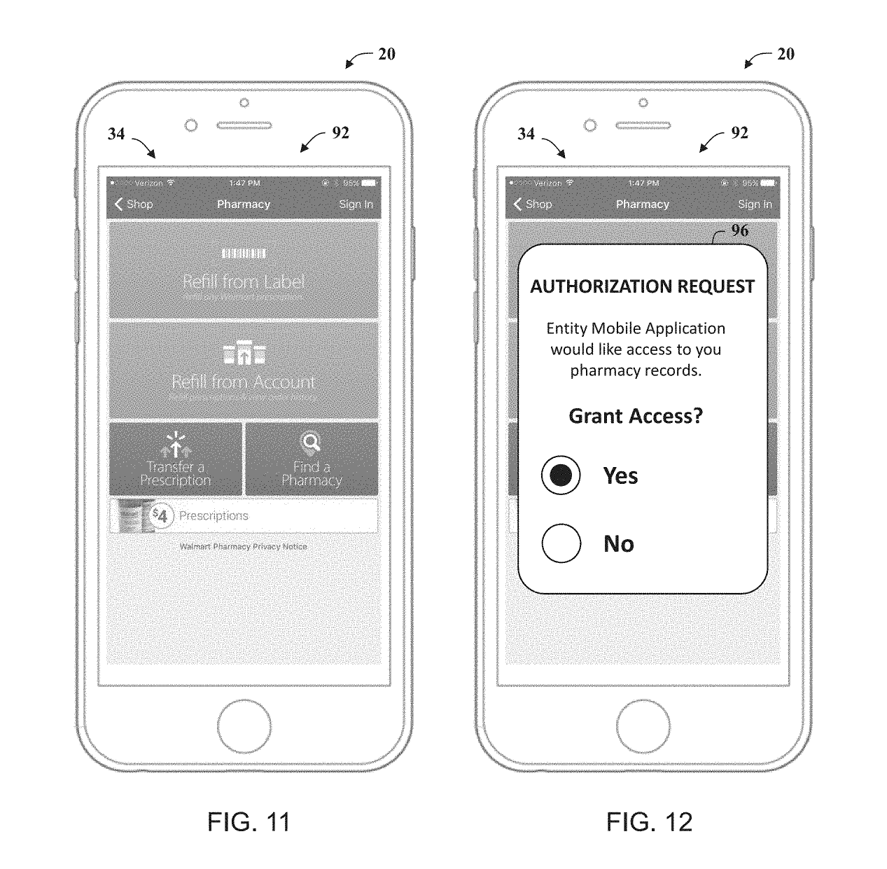

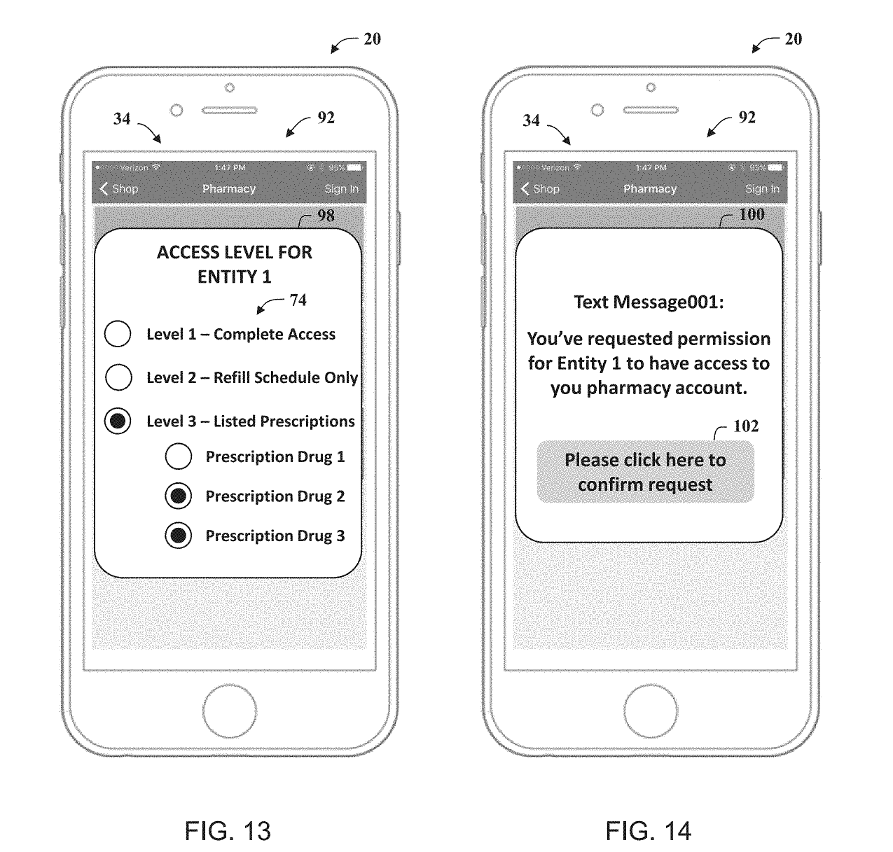

In the illustrated embodiment, the mobile computing device 20 includes a web browser program stored in the memory device. The processor executes the web browser program to display web pages on the touchscreen display device 22 that includes information received from the server system 12 to enable a user to interact with and operate the server system 12. In addition, the mobile computing device 20 may be programmed to store and execute a computer program applications that display user interfaces 34 (shown in FIGS. 10-14) on the touchscreen display device 22 that allows the user to access the server system 12 to retrieve and store information within the server system 12 as well as interact with and operate the server system 12. In addition, in one embodiment, the system 10 may install one or more mobile computer application programs in the memory device of the mobile computing device 20. When initiated by the processor of the mobile computing device 20, the mobile computer application program causes the processor of the mobile computing device 20 to perform some or all of the functions of the server system 12.

In the illustrated embodiment, the 3^{rd} party entity server systems 16 is associated with service entities that provide goods and/or services to pharmacy customers. The server system 12 is programmed to communicate with the 3^{rd} party entity server systems 16 to transmit and receive information associated with pharmacy customers to enable the 3^{rd} party entity server systems 16 to provide additional services to the pharmacy customers. For example, in one embodiment, the 3^{rd} party entity server systems 16 may be associated with organizations and/or companies that provide healthcare services to consumers such as, for example, health insurance companies, medical providers, healthcare professionals, hospitals, medical care facilities, healthcare monitoring entities, consumer product companies, consumer retail establishments, and the like. In addition, in some embodiments, the 3^{rd} party entity server systems 16 may be associated with systems supporting mobile computer application programs being stored on the mobile computing devices 20 associated with pharmacy customers. For example, one or more 3^{rd} party entity server systems 16 may be configured to support mobile computer applications that are programmed to provide medication adherence computer services that facilitate managing a pharmacy customers medication dosage by providing a user interface experience via the mobile computing device 20 that provides reminder notifications and/or calendar events to assist the pharmacy customer in managing medications. In other embodiments, the 3^{rd} party entity server systems 16 may include computer programs associated with tracking health and activity levels of pharmacy customers via the corresponding mobile computing devices 20.

In the illustrated embodiment, the server system 12 includes a website hosting server 36, e-receipts server 38, a pharmacy account server 40, an authentication server 42, a database server 44, and a database 46. The database server 44 includes a memory device that is connected to the database 46 to retrieve and store information contained in the database 46. The database 46 contains information on a variety of matters, such as, for example, web pages associated with one or more websites, search queries, pharmaceutical drug information, refill information, entity authentication information, customer pharmacy account information, product records, notification messages, mobile device identifies, mobile device application program interfaces (APIs), and/or any suitable information that enables the system 10 to function as described herein. In one embodiment, some or all of the information contained in the database 46 may also be stored in the database of the mobile computing device 20.

In the illustrated embodiment, the database 46 includes a pharmacy account list 48 (shown in FIG. 6) that includes a plurality of user pharmacy account records 50. Each user pharmacy account record 50 is associated with a corresponding pharmacy customer and includes user identification information 52 associated with the pharmacy customer and pharmaceutical drug data associated with pharmaceutical drugs prescribed to and/or purchased by the corresponding pharmacy customer. The user identification information 52 includes user identifying data such as, for example, a unique user ID and/or password. The user identification information 52 may also include user contact information such as, for example, a phone number, an email, and/or a mobile device data 54 associated with a mobile computing device 20 associated with the corresponding pharmacy customer. For example, the mobile device data 54 may include, but is not limited to, a unique mobile device ID, operating system, phone number, IP address, mobile device API, and/or any suitable information that enables the system 10 to communicate with the corresponding mobile computing device 20.

In the illustrated embodiment, each user pharmacy account record 50 includes a plurality of data categories 56 associated with the pharmaceutical drugs prescribed to and/or purchase by the pharmacy customer. The data categories 56 includes information associated with the pharmaceutical drugs and activities associated with the pharmacy customers. For example, in one embodiment, each user pharmacy account record 50 may include a first data group 58 including data categories 56 including information associated with a corresponding pharmaceutical drug and a second data group 60 including data categories including information indicating pharmacy customer activities associated with the corresponding pharmaceutical drug. The first data group 58 may include data categories 56 including information indicating a unique drug ID associated with the pharmaceutical drug, pharmaceutical drug description, drug category, prescribed use information, dosage information, and/or any suitable information associated with the corresponding pharmaceutical drug. The second data group 60 may include data categories 56 including information indicating a number of refills remaining, a refill frequency, a date and/or time of the last refill purchase, purchase date, and/or prescription expiration, and/or any suitable information associated with pharmacy customer activity.

In one embodiment, the database 46 may also include an entity authentication list 62 (shown in FIG. 6) that includes a plurality of authenticated entity records 64 that are associated with one or more 3^{rd} party entity server systems 16. The entity authentication list 62 includes 3^{rd} party entities that have been previously validated and approved to receive pharmacy information associated with pharmacy customers. For example, in one embodiment the entity authentication list 62 includes 3^{rd} party entities that include computers server systems and operations that are compliant with the Health Insurance Portability and Accountability Act (HIPPA) and are approved for the secured transmission and receipt of healthcare related patient data. Each authenticated entity record 64 includes information associated with a corresponding 3^{rd} party entity server system 16 including a unique entity ID 66 and an authentication data file 68 including unique information associated with the corresponding 3^{rd} party entity server system 16 for use in verifying the identity of the 3^{rd} party entity server system 16. For example, the authentication data file 68 may include a message authentication code and/or a digital signature code for use in generating and receiving encrypted information from the corresponding 3^{rd} party entity server system 16.

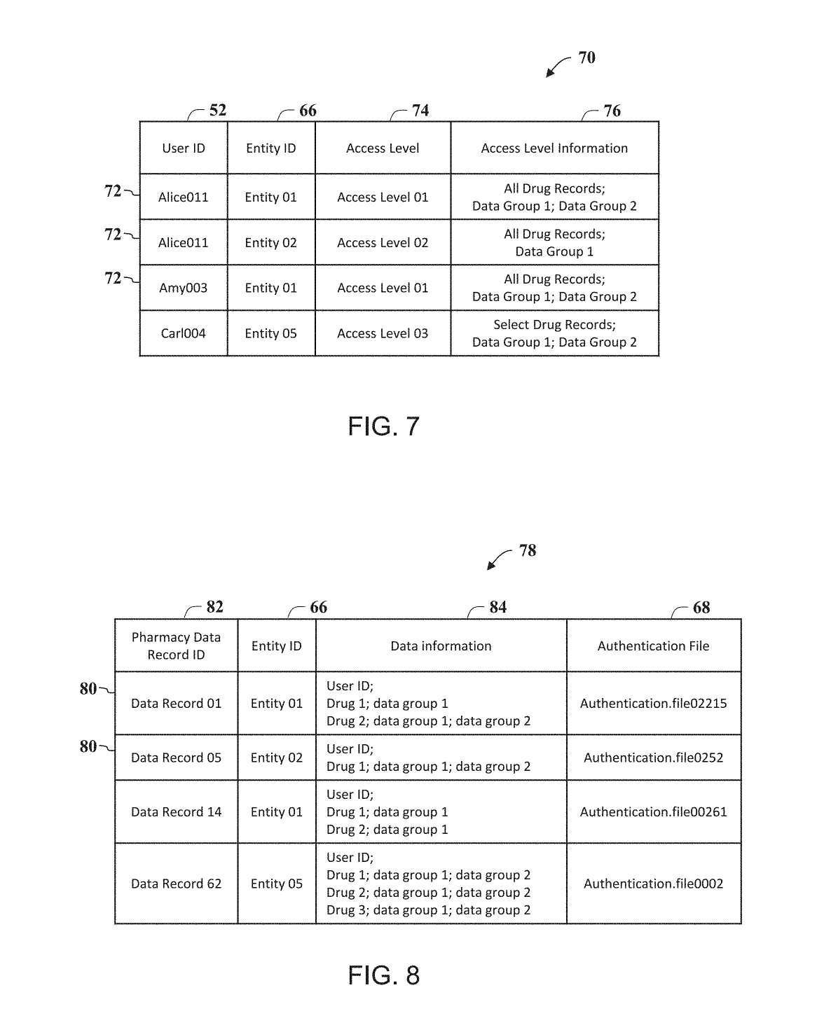

The database 46 may also include a user-entity access list 70 (shown in FIG. 7) that includes a plurality of user access records 72. Each user access record 72 includes a user ID 52 associated with a corresponding pharmacy customer, an entity ID 66 associated with a corresponding 3^{rd} party entity server system 16, a data access level 74 associated with information contained in the user pharmacy account records 50, and an access level information file 76 including instructions on the type and amount of information to be retrieved from the user pharmacy account records 50 based on the corresponding data access level 74. Each data access level 74 indicates an amount of pharmacy customer information that may be provided to a 3^{rd} party entity server system 16. Each access level information file 76 may include instructions to retrieve information included in one or more data categories 56 included in the user pharmacy account records 50 including information associated with corresponding pharmaceutical drug and information indicating pharmacy customer activities. The user-entity access list 70 may include a plurality of data access levels associated with different amounts of information contained in the user pharmacy account records 50. For example, in one embodiment, the user-entity access list 70 may include a first data access level that allows access to information contained in each of the data categories 56 included in a user pharmacy account record 50 and a second data access level that allows access to information contained in a limited number of data categories 56 included in the user pharmacy account record 50. For example, the second data access level may include a corresponding access level information file 76 including instructions to provide access only to information included in the first data group 58. In addition, the second data access level may limit access to information associated with one or more selected pharmaceutical drugs included in the user pharmacy account record 50. In one embodiment, for example, the first data access level may include the first data group 58 and the second data access level may include the second data group 60. In another embodiment, the first data access level may include the first data group 58 and the second data group 60, and the second data access level may include only the first data group 58 or the second data group 60.

The database 46 may also include a pharmacy data records list 78 (shown in FIG. 8) that includes a plurality of pharmacy data records 80 indicating information being transmitted to the 3^{rd} party entity server systems 16. The pharmacy data records 80 are generated as a function of the instructions included in the access level information files 76. Each pharmacy data record 80 includes a pharmacy record ID 82, an entity ID associated with a 3^{rd} party entity server system 16, a data information file 84 including information retrieved from a user pharmacy account record 50, and an authentication data file 68 including file encryption instructions and information.

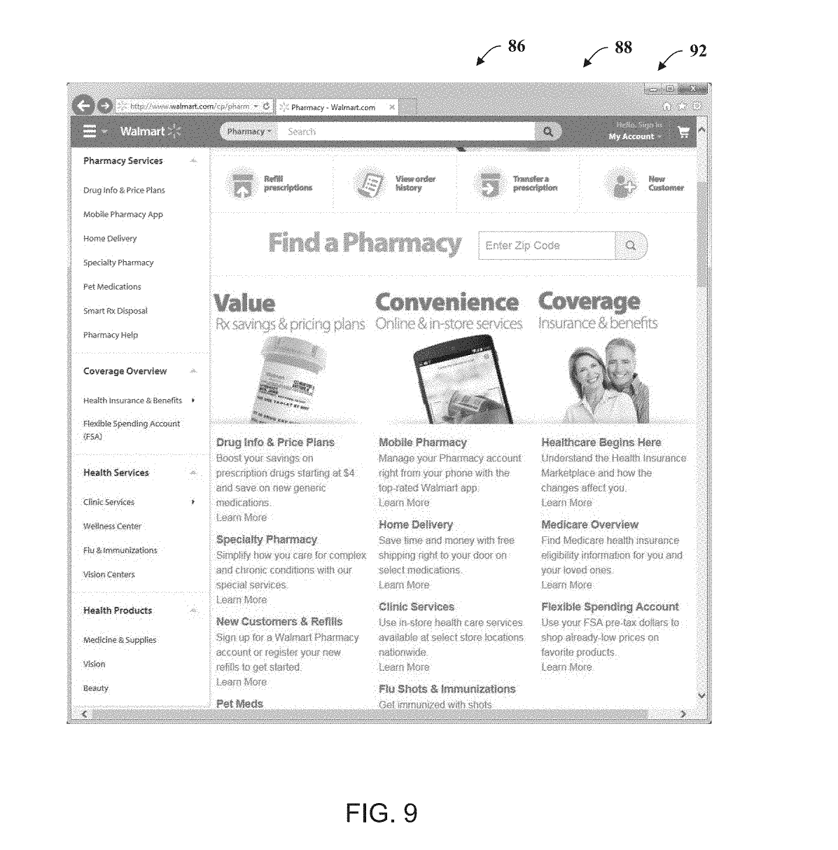

The website hosting server 36 is configured to host a website 86 that is accessible by a user via one or more user computing devices 14. The website hosting server 36 retrieves and stores web pages 88 (shown in FIG. 9) associated with one or more websites 86 in response to requests received by the user via the user computing device 14 to allow users to interact with the website and search and/or purchase products such as, for example, goods and/or services via the website. In one embodiment, the website hosting server 36 is configured to generate and display web pages 88 associated with the website in response to requests being received from consumers via corresponding web browsers that are displayed on the user computing devices 14. In addition, the website hosting server 36 may be configured to generate and display a mobile webpage 90 (shown in FIG. 10-16) that is displayed on one or more mobile computing devices 20. For example, in one embodiment, the website hosting server 36 may display a pharmacy webpage 92 (shown in FIGS. 9-16) in response to receiving a user request that allows a user to access a corresponding user pharmacy account record 50, input product search requests including search criteria including one or more search terms, purchase pharmaceutical drugs, request prescription refills, request pharmacist consultations, schedule pharmacy and/or medical clinic appointments, and the like.

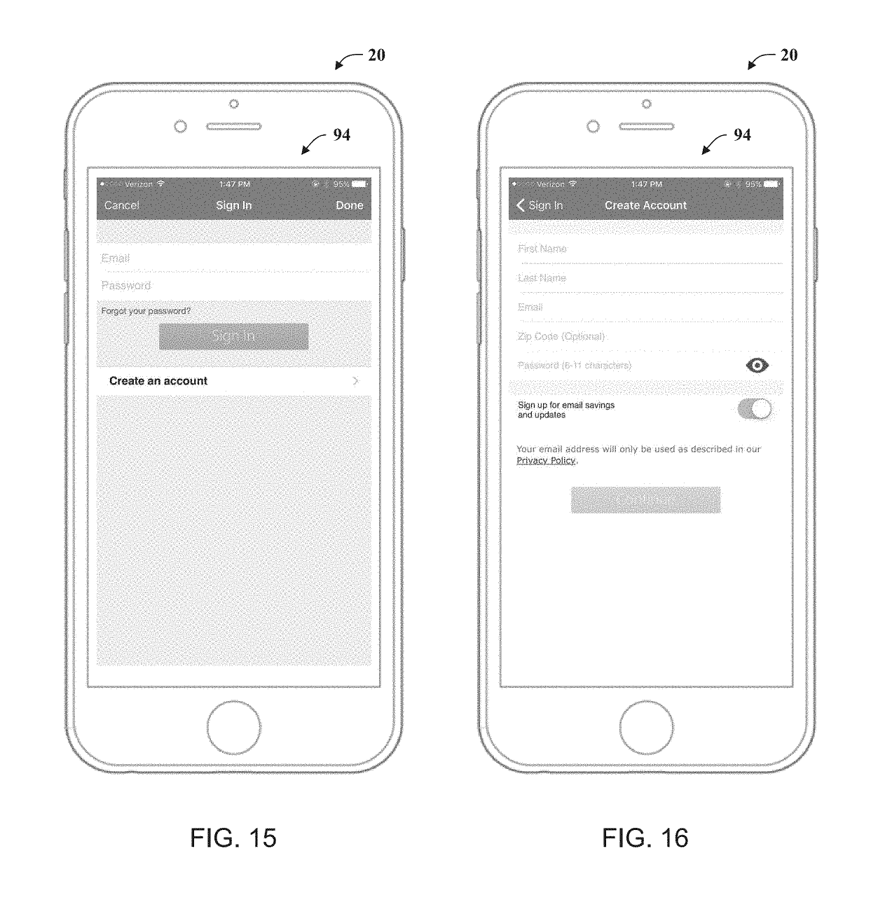

The website hosting server 36 may allow customers to login and access corresponding customer pharmacy accounts including account information such as, for example, previous purchases, pending proscription orders, pending medication refills, and/or pharmaceutical drug information. For example, the website hosting server 36 may display a login page 94 (shown in FIGS. 15-16), receive a unique customer ID such as, for example, a username and/or password, and identify the customer account associated with the unique customer ID to enable the identified customer to access information and/or features associated with the corresponding customer pharmacy account.

In addition, the website hosting server 36 may also allow pharmacy customers to request authorization to provide information included in the user pharmacy account records 50 to one or more 3^{rd} party entity server systems 16. For example, in one embodiment, the website hosting server 36 may display an authorization request screen 96 (shown in FIG. 12) that allows a pharmacy customer to request the system 10 to provide pharmacy customer information to an entity server system 16. The authorization request screen 96 may include information associated with the 3^{rd} party entity server system 16 and include a request to authorize the entity server system 16 to receive pharmacy records associated with the pharmacy customer. In addition, the authorization request screen 96 allows the pharmacy customer to transmit signals to the system 10 indicating corresponding selections being made by the pharmacy customer via the authorization request screen 96.

In one embodiment, the website hosting server 36 may also allow a pharmacy customer to select the type and amount of pharmacy customer information being provided to the 3^{rd} party entity server system 16. For example, in one embodiment, the website hosting server 36 may display an access level authorization screen 98 including a list of predefined data access levels 74 and allow the pharmacy customer to select one or more data access levels 74 and associate the selected data access levels 74 with the corresponding 3^{rd} party entity server system 16. The access level authorization screen 98 allows the pharmacy customer to transmit signals to the system 10 indicating corresponding selections being made by the pharmacy customer via the access level authorization screen 98.

The e-receipts server 38 receives and stores information associated with consumer retail purchases in the database 46 and is programmed to generate and store electronic receipt data associated with the consumer retail purchases. In addition, the e-receipts server 38 may be programmed to transmit signals indicating pharmacy customer purchases to the pharmacy account server 40. In one embodiment, the e-receipts server 38 may communicate with a plurality of point-of-sale (POS) systems as well as other computer systems at each of the one or more physical store locations (e.g., on an internal corporate network) to facilitate business operations for the corresponding entity. For example, a pharmacy customer may purchase a pharmaceutical drug using a POS system at a store location. The e-receipts server 38 may generate e-receipt data indicating the purchase and transmit the e-receipt data to the pharmacy account server 40 for use in modifying a corresponding user pharmacy account record 50 to include information associated with the pharmaceutical drug purchase.

The e-receipts server 38 is programed to receive application identifiers and digital receipt data, including item data for one or more purchased items, from POS systems at various different store locations, and generate and store digital receipts from received receipt data. Generating digital receipts can include item data for items included in corresponding digital receipt data (but potentially in a different format, for example, a format deliverable to mobile devices). Formulated digital receipts can also contain other data related to a transaction, such as, for example, the payment method used for the transaction, coupons, surveys, etc. Additional details of adjacent special symbol positions, which may be used in the present invention, are described in U.S. patent application Ser. No. 13/730,721 to Argue et al., filed Dec. 28, 2012, titled “Searching Digital Receipts at a Mobile Device”, the disclosure of which is incorporated herein by reference in its entirety.

In the illustrated embodiment, the pharmacy account server 40 is programmed to monitor activities of pharmacy customers including the purchase and use of prescription pharmaceutical medications, to generate and store pharmacy records associated with the pharmacy customer activities, and to receive and transmit information to one or more 3^{rd} party entity server system 16. For example, in one embodiment, the pharmacy account server 40 may provide pharmacy customer information to an entity server system 16 for use in providing value-added services to the pharmacy customer such as, for example, health monitoring services, health insurance services, medication adherence services, consumer products, health education services, and/or any suitable services that may use information being generated by the pharmacy account server 40. For example, in one embodiment, the 3^{rd} party entity server system 16 may be associated with a medication adherence mobile computer program application being stored on a pharmacy customer's mobile computing device 20. The pharmacy account server 40 may be configured to transmit information associated with medications being prescribed to the pharmacy customer to the entity server system 16 for use in operating the medication adherence mobile application.

In the illustrated embodiment, the pharmacy account server 40 includes a server computer including a processor coupled to a memory device. The pharmacy account server computer processor is programmed to receive a signal indicating a request to transmit a pharmacy record to an entity server system 16. The request may include an entity ID associated with the entity server system 16 and a user ID associated with a pharmacy customer. In one embodiment, the request may be received from the corresponding entity server system 16 via the communications network 18 and/or via a mobile computer program application being associated with the entity server system 16 and being executed by a mobile computing device 20 associated with the pharmacy customer. The request may also be received from the pharmacy customer via a corresponding user computing device 14, mobile computing device 20, and/or a webpage being displayed by the website hosting server 36. Upon receiving the request to transmit a pharmacy record, the pharmacy account server 40 initiates a verification operation to verify an identity of the entity server system 16 and transmits a validation request to the authentication server 42. The authentication server 42 validates the identity of the entity server system 16 and transmits a validation confirmation message to the pharmacy account server 40. In addition, the authentication server 42 may also transmit a validation failure message to the pharmacy account server 40 if the authentication server 42 cannot validate the identity of the entity server system 16.

In the illustrated embodiment, the pharmacy account server 40 accesses the pharmacy account list 48 upon receiving the validation confirmation message verifying the identity of the entity server system 16 and selects a user pharmacy account record 50 associated with the user ID received in the request to transmit a pharmacy record. In one embodiment, the request may include a mobile device ID. The pharmacy account server 40 may identify a user pharmacy account record 50 that includes a mobile device ID matching the received mobile device ID. In the illustrated embodiment, the pharmacy account server 40 retrieves the information included in the selected user pharmacy account record 50, generates a pharmacy data record 80 as a function of the selected user pharmacy account record 50, and transmits the generated pharmacy data record 80 to the entity server system 16. In addition, the pharmacy account server 40 may generate the pharmacy data record 80 including pharmaceutical drug information included in the selected user pharmacy account record 50. In one embodiment, the pharmacy account server 40 may access the entity authentication list 62 to retrieve the authentication data file 68 associated with the entity ID and generate an encrypted message including the pharmacy data record 80 to securely transmit the pharmacy account record to the corresponding entity server system 16.

In one embodiment, the pharmacy account server 40 may also be programmed to access the user-entity access list 70 upon verifying the identity of the entity server system 16 and select a user access record 72 associated with the received user ID. The pharmacy account server 40 may also determine a corresponding data access level 74 included in the user access record 72 and generate the pharmacy data record 80 as a function of the corresponding data access level 74 associated with the selected user access record 72. In one embodiment, the user access record 72 may include a plurality of entity server systems 16 that are associated with the user ID, and a plurality of data access levels associated with each of the entity server systems 16. The pharmacy account server 40 may select an entity ID included in the user access record 72 matching the received entity ID received in the request to transmit pharmacy records, determine the data access level 74 associated with the matching entity ID, and generate the pharmacy data record 80 as a function of the data access level 74 associated with the matching entity ID.

The pharmacy account server 40 may also access the access level information file 76 associated with the data access level 74 included in the user access record 72 and execute the corresponding instructions to determine the data categories 56 associated with the data access level 74. The pharmacy account server 40 may then access the user pharmacy account record 50, retrieve the data categories described in the access level information file 76, and generate the pharmacy data record 80 including the retrieved information. For example, in one embodiment, the pharmacy account server 40 may be programmed to execute the instructions included in the access level information file 76 and select a group of data categories from the plurality of data categories as function of the corresponding data access level 74, and generate the pharmacy data record 80 including the selected data categories.

The pharmacy account server 40 may also be programmed to initiate an authorization operation to facilitate generating the pharmacy data records 80. In one embodiment, the pharmacy account server 40 may initiate the authorization operation upon receiving the request to transmit a pharmacy data record. In another embodiment, the pharmacy account server 40 may initiate the authorization operation upon receiving a request from a pharmacy customer via the pharmacy website.

The pharmacy account server 40 initiates the authorization operation including displaying the authorization request screen 96 to the pharmacy customer via a user computing device 14 and requesting the pharmacy customer to authorize the entity server system 16 to receive pharmacy records associated with the pharmacy customer. The authorization request screen 96 enables the pharmacy customer to interact with the pharmacy account server 40 and transmit requests to authorize the entity server system 16 to receive pharmacy data records 80 associated with the pharmacy customer. In one embodiment, the pharmacy account server 40 initiates the authorization operation including requesting the user ID associated with the pharmacy customer, accessing the pharmacy account list 48 to identify the user pharmacy account record 50 associated with the received user ID, identify a mobile computing device 20 associated with the pharmacy customer as a function of the received user ID and selected user pharmacy account record 50, and display the authorization request screen 96 on the identified mobile computing device 20.

The pharmacy account server 40 is programmed to receive a request to authorize the entity server system 16 to receive pharmacy data records 80 from the pharmacy customer by receiving signals indicating corresponding selections being made by the pharmacy customer via the authorization request screen 96. Upon receiving a request to authorize the entity server system 16 to receive pharmacy records associated with the pharmacy customer, the pharmacy account server 40 generates a user access record 72 associated with the pharmacy customer including the received user ID and the received entity ID.

In one embodiment, the pharmacy account server 40 may also display the access level authorization screen 98 including a list of data access levels 74 in response to receiving the request to authorize the entity server system 16. The pharmacy customer selects the desired data access level and the pharmacy account server 40 receives the selection of a data access level 74 from the pharmacy customer via the mobile computing device 20, and generates the user access record 72 including the selected data access level 74.

In one embodiment, the pharmacy account server 40 may also access the user pharmacy account record 50 associated with the user ID, retrieve contact information associated with the corresponding pharmacy customer, and transmit a verification message 100 (shown in FIG. 14) to the pharmacy customer based on the retrieved contact information. The verification message 100 may include a verification hyperlink 102 including verification data that allows the pharmacy customer to access the hyperlink and transmit a verification signal to the pharmacy account server 40. The pharmacy account server 40 may be programmed to generate the user access record 72 upon receiving the verification signal indicating the verification hyperlink 102 being accessed by the pharmacy customer. For example, in one embodiment, the user pharmacy account record 50 may include an email address and/or a phone number associated with a phone capable of received SMS text messages. The pharmacy account server 40 may generate the verification message 100 including an email message and/or SMS text message and transmit the email message and/or SMS text message including the verification hyperlink 102 to the pharmacy customer.

The authentication server 42 is programmed to execute the verification operation to verify an identity of the entity server system 16 upon receiving a validation request from the pharmacy account server 40. The authentication server 42 validates the identity of the entity server system 16 and transmits a validation confirmation message to the pharmacy account server 40 upon validating the identity of the entity server system 16. In one embodiment, the validation request may include the entity ID received in the request to transmit a pharmacy data record. The authentication server 42 accesses the entity authentication list 62, determines an authenticated entity record 64 having an entity ID matching the received entity ID, and transmits the a validation confirmation message to the pharmacy account server 40 including the matching authenticated entity record 64. In one embodiment, the validation request may include authentication information received from the entity server system 16. The authentication server 42 may access the authentication data file 68 included in the selected authenticated entity record 64 and transmit the validation confirmation message if the received authentication information matches the information included in the authentication data file 68. For example, the authentication information may include a digital signature receive from the entity server system 16. The authentication server 42 determines if the received digital signature matches the digital signature contained in the authentication data file 68, and transmit the validation confirmation message upon determining a matching digital signature.

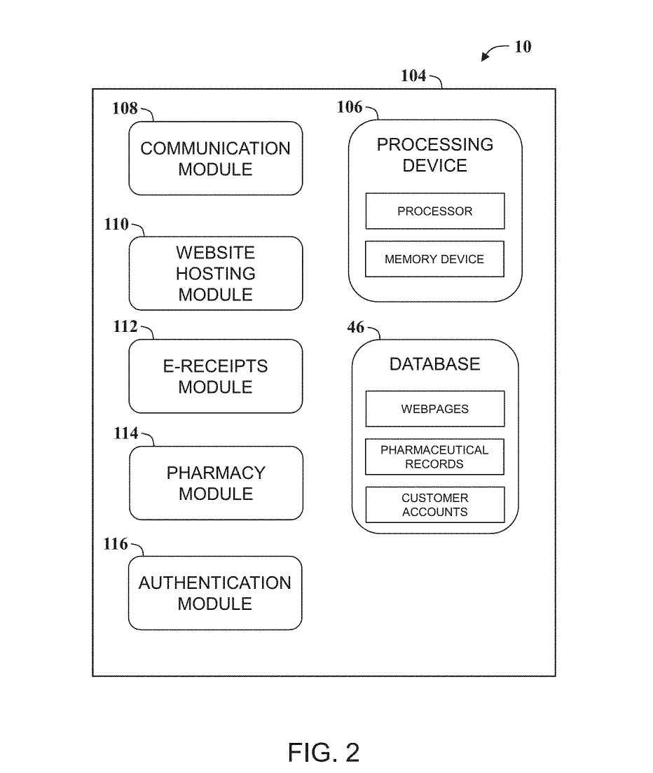

Referring to FIG. 2, in one embodiment, the system 10 may include a system server 104 that is configured to perform the functions of the website hosting server 36, the e-receipts server 38, the pharmacy account server 40, the authentication server 42, and the database server 44. In the illustrated embodiment, the system server 104 includes a processing device 106 and the database 46.

The processing device 106 executes various programs, and thereby controls components of the system server 104 according to user instructions received from the user computing device 14. The processing device 106 may include memory, e.g., read only memory (ROM) and random access memory (RAM), storing processor-executable instructions and one or more processors that execute the processor-executable instructions. In embodiments where the processing device 106 includes two or more processors, the processors can operate in a parallel or distributed manner. In an example, the processing device 106 may execute a communications module 108, a the website hosting module 110, an e-receipts module 112, a pharmacy account module 114, and an authentication module 116,

The processing device 106 may also include a memory device for storing programs and information in the database 46, and retrieving information from the database 46 that is used by the processor to perform various functions described herein. The memory device may include, but is not limited to, a hard disc drive, an optical disc drive, and/or a flash memory drive. Further, the memory device may be distributed and located at multiple locations.

The communications module 108 retrieves various data and information from the database 46 and sends information to the user computing device 14 via the communications network 18 to enable the user to access and interact with the system 10. In one embodiment, the communications module 108 displays various images on a graphical interface of the user computing device 14 preferably by using computer graphics and image data stored in the database 46 including, but not limited to, web pages, pharmacy records, pharmacy notification messages, product lists, and/or any suitable information and/or images that enable the system 10 to function as described herein.

The website hosting module 110 may be programmed to perform some or all of the functions of the website hosting server 36 including hosting various web pages associated with one or more websites that are stored in the database 46 and that are accessible to the user via the user computing device 14. The website hosting module 110 may be programmed to generate and display web pages associated with a website in response to requests being received from users via corresponding web browsers.

The e-receipts module 112 may be programmed to perform some or all of the functions of the e-receipts server 38 including generating, receiving, and storing e-receipt data in the database 46 and detecting purchases being made by the pharmacy customers.

The pharmacy account module 114 may be programmed to perform some or all of the functions of the pharmacy account server 40 including monitoring activities associated with pharmacy customers including consumer purchase and/or proscription refill requests, generate notification messages associated with the monitored activities, transmit and received data from 3^{rd} party entity server systems 16, and executing verification and authorization operations.

The authentication module 116 may be programmed to perform some or all of the functions of the authentication server 42 including executing the verification operation to verify an identity of the entity server system 16 upon receiving a validation request from the pharmacy account server 40.

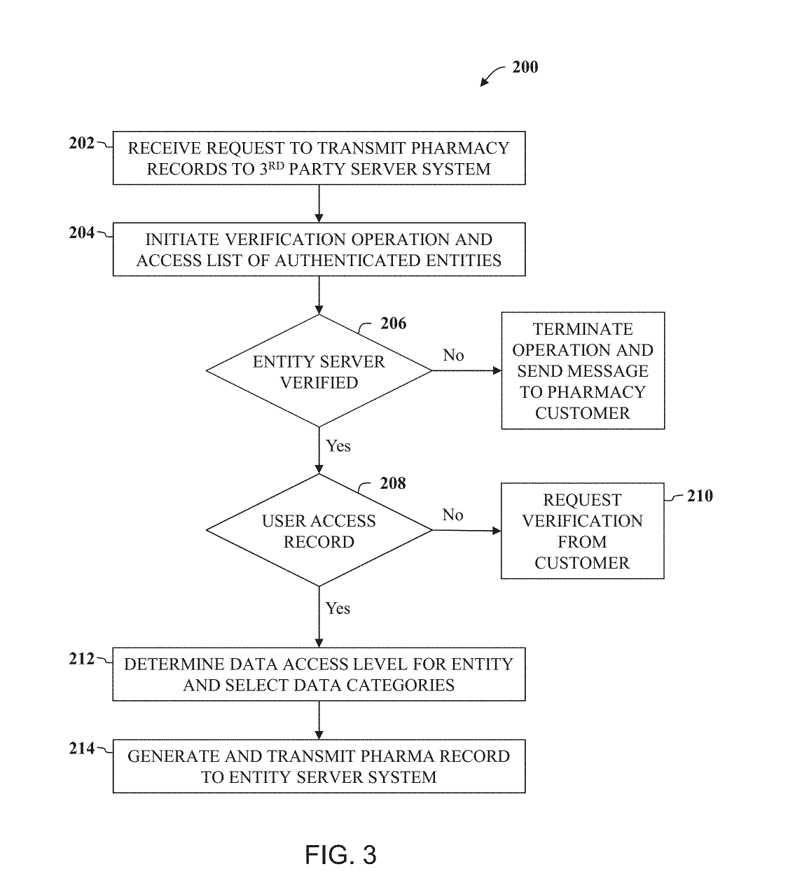

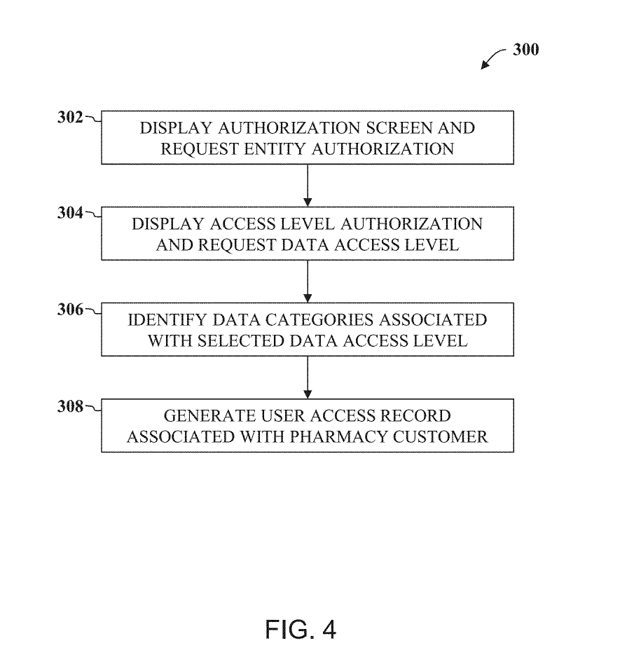

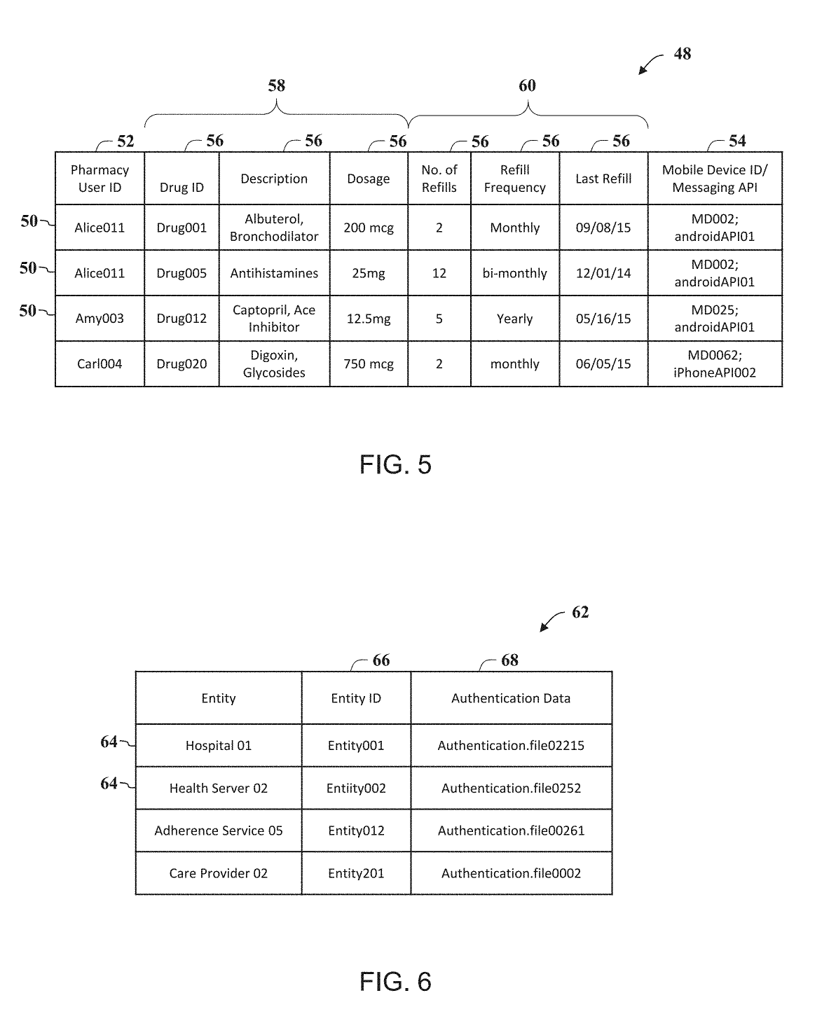

FIGS. 3-4 are flowcharts of methods 200 and 300 that may be used with the system 10 for monitoring activities of pharmacy customers and generating pharmaceutical data for use by 3^{rd} party entity server systems. The methods include a plurality of steps. Each method step may be performed independently of, or in combination with, other method steps. Portions of the methods may be performed by any one of, or any combination of, the components of the system 10. FIGS. 9-16 are exemplary graphical displays that may be displayed by the system 10.

In the illustrated embodiment, in method step 202, the pharmacy account server 40 receives a request to transmit pharmacy records to a 3^{rd} party entity server system 16. In one embodiment, the pharmacy account server 40 may receive a signal indicating the request for pharmacy records from the 3^{rd} party entity server system 16. In another embodiment, the pharmacy account server 40 may receive the request from a mobile computer application associated with the 3^{rd} part entity server system 16 and being executed on a mobile computing device 20 associated with a pharmacy customer. The request may include an entity ID associated with the 3^{rd} party entity server system and/or a user ID associated with a pharmacy customer. The pharmacy account server 40 accesses the pharmacy account list 48 to retrieve a user pharmacy account record 50 as a function of the received user ID.

In method step 204, the pharmacy account server 40 initiates a verification operation and transmits a validation request to the authentication server 42 including the entity ID and/or entity authentication data included in the received request to transmit pharmacy records. The authentication server 42 executes the verification operation and accesses the entity authentication list 62 to determine if the received entity ID and/or entity authentication data matches information contained in an authenticated entity record. Upon validating the identity of the 3^{rd} party entity server system 16 the authentication server 42 transmits a validation confirmation message to the pharmacy account server 40. If the identify of the 3^{rd} party entity server system 16 cannot be validated, the authentication server 42 transmits a validation failure message to the pharmacy account server 40, and the pharmacy account server 40 terminates the verification operation and transmits a validation failure notification message to the pharmacy customer.

Upon receiving the validation confirmation message, the pharmacy account server initiates method step 206 and accesses the user-entity access list 70 to determine if the user-entity access list 70 includes a user access record 72 having a user ID and entity ID matching the received user ID and entity ID included in the received request to transmit pharmacy data records. If the pharmacy account server 40 identifies a matching user access record 72, the pharmacy account server 40 initiates method step 208. If the pharmacy account server 40 does not identify a matching user access record 72 the pharmacy account server 40 initiates method step 210 and executes the authorization operation including displaying the authorization request screen 96 to the pharmacy customer via a user computing device 14.

In method step 212, the pharmacy account server 40 accesses the identified user access record 72 and retrieves the data access level 74 and the access level information file 76 included in the user access record 72 and selects the data categories 56 to be include in the pharmacy data records 80 as a function of the retrieved data access level 74 and the access level information file 76.

In method step 214, the pharmacy account server 40 accesses the retrieved user pharmacy account record 50, retrieves the information included in the selected data categories 56, and generates a pharmacy data record 80 including the retrieved information. The pharmacy account server 40 also retrieves the authentication data file 68 included in the corresponding authenticated entity record 64, generates an encrypted message including the pharmacy data record 80 including a data information file 84 including information retrieved from a user pharmacy account record 50, and an authentication data file 68 including file encryption instructions and information, and transmits the encrypted message to the entity server system 16.

Referring to FIG. 4, in one embodiment, the pharmacy account server 40 may implement method 300 to execute the authorization operation to facilitate generating the pharmacy data records 80. In the illustrated embodiment, in method step 302 the pharmacy account server 40 displays the authorization request screen 96 to the pharmacy customer to request authorization to transmit pharmacy data records to the entity server system 16. In one embodiment, the pharmacy account server 40 may access a user pharmacy account record associated with the pharmacy customer to retrieve a mobile device ID and corresponding mobile application API, identify a mobile computing device 20 associated with the pharmacy customer based on the retrieved mobile device ID, and generate and transmit a signal to the identified mobile device ID as a function of the retrieved mobile application API to cause the mobile computing device 20 to display the authorization request screen 96.

In method step 304, upon receiving a selection to permit authorization from the pharmacy customer, the pharmacy account server 40 generates and displays the access level authorization screen 98 including a list of data access levels 74, and allows the pharmacy customer to select the desired data access level associated with the authorized 3^{rd} party entity server system 16.

In method step 306, the pharmacy account server 40 identifies the data categories 56 associated with the selected data access level 74, and initiates method step 308 to generate a user access record 72 associated with the pharmacy customer and the authorized 3^{rd} party entity server system 16 including the access level information file 76 associated with the selected data access level 74.

In general, the system 10 is configured to monitor activities of pharmacy customers and generate pharmacy user account records including information associated with pharmaceutical medications being used by pharmacy customers. In addition, the system 10 is configured to facilitate communication with 3^{rd} party server systems to enable 3^{rd} party entities to provide value-added serves to pharmacy customers using data and information generated by the system 10. Moreover, the system 10 allows pharmacy customers to identify the type and amount of information that may be provided to the 3^{rd} party entities. By generating user pharmacy account records that include data indicating information that may be provided to 3^{rd} party entities, and allowing users to select the type and amount of pharmacy customer information that may be provided, the system 10 improves the speed and functionality of known computing systems by reducing the amount of computing time required to monitor customer activity and generate data records being transmitted to value added entities, thus reducing the computing resources required to generate and maintain pharmacy customer records.

A controller, computing device, server or computer, such as described herein, includes at least one or more processors or processing units and a system memory (see above). The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention.

What is claimed is:

1. A system, comprising:
a database including a list of user pharmacy account records and a list of authenticated entity records, each user pharmaceutical account record including a pharmacy user ID associated with a pharmacy customer and pharmaceutical drug information associated with corresponding prescription drug medications, each authenticated entity record including a unique entity ID and corresponding authentication data; and
a server computer including a processor coupled to a memory device, the processor programmed to:
receive a request to transmit a pharmacy record to an entity server system, the request including an entity ID associated with the entity server system and a user ID associated with a pharmacy customer;
initiate a verification operation to verify an identity of the entity server system upon receiving the request including accessing the list of authenticated entity records and determining an authenticated entity record having an entity ID matching the received entity ID;
access the list of user pharmacy account records upon verifying the identity of the entity server system and selecting a user pharmacy account record associated with the received user ID;
generate a pharmacy data record as a function of the selected user pharmacy account record; and
transmit the generated pharmacy data record to the entity server system.

2. A system in accordance with claim 1, wherein the server computer is programmed to:
generate the pharmacy data record including pharmaceutical drug information included in the selected user pharmacy account record.

3. A system in accordance with claim 1, the server computer is programmed to:
access a user-entity access list including a plurality of user access records being stored in the database upon verifying the identity of the entity server system, each user access record including a user ID and a data access level;
select a user access record associated with the received user ID and determine a corresponding data access level; and
generate the pharmacy data record as a function of the corresponding data access level associated with the selected user access record.

4. A system in accordance with claim 3, wherein the selected user pharmacy account record includes a plurality of data categories, the server computer is programmed to:
select a group of data categories from the plurality of data categories as function of the corresponding data access level; and
generate the pharmacy data record including the selected data categories.

5. A system in accordance with claim 4, wherein the user-entity access list includes a plurality of data access levels including a first data access level associated with a first group of data categories and a second data access level associated with a second group of data categories.

6. A system in accordance with claim 5, wherein the first group of data categories includes information associated with a corresponding pharmaceutical drug and the second group of data categories includes information indicating customer refills associated with the corresponding pharmaceutical drug.

7. A system in accordance with claim 1, wherein the server computer is programmed to:
identify a mobile computing device associated with the pharmacy customer as a function of the received user ID;
display an authorization request screen on the identified mobile computing device requesting the pharmacy customer to authorize the entity server system to receive pharmacy records associated with the pharmacy customer;
receive, from the pharmacy customer via the mobile computing device, a request to authorize the entity server system to receive pharmacy records associated with the pharmacy customer; and
generate a user access record associated with the pharmacy customer including the received user ID and the received entity ID.

8. A system in accordance with claim 7, wherein the server computer is programmed to:
display an access level authorization screen including a list of data access levels in response to receiving the request to authorize the entity server system;
receive a selection of a data access level from the pharmacy customer via the mobile computing device; and
generate the user access record including the selected data access level.

9. A system in accordance with claim 8, wherein the server computer is programmed to:
retrieve contact information associated with the received user ID;
transmit a verification message to the pharmacy customer as a function of the retrieved contact information, the verification message including a hyperlink including verification data; and
generate the user access record upon receiving a signal indicating the hyperlink being accessed by the pharmacy customer.

10. A method comprising:
receiving a request to transmit a pharmacy record to an entity server system, the request including an entity ID associated with the entity server system and a user ID associated with a pharmacy customer;
accessing a database including a list of user pharmacy account records and a list of authenticated entity records, each user pharmaceutical account record including a pharmacy user ID associated with a pharmacy customer and pharmaceutical drug information associated with corresponding prescription drug medications, each authenticated entity record including a unique entity ID and corresponding authentication data;
initiating a verification operation to verify an identity of the entity server system upon receiving the request to transmit a pharmacy record including accessing the list of authenticated entity records and determining an authenticated entity record having an entity ID matching the received entity ID;
accessing the list of user pharmacy account records upon verifying the identity of the entity server system and selecting a user pharmacy account record associated with the received user ID;
generating a pharmacy data record as a function of the selected user pharmacy account record; and
transmitting the generated pharmacy data record to the entity server system.

11. A method in accordance with claim 10, further comprising generating the pharmacy data record including pharmaceutical drug information included in the selected user pharmacy account record.

12. A method in accordance with claim 10, further comprising:
accessing a user-entity access list including a plurality of user access records being stored in the database upon verifying the identity of the entity server system, each user access record including a user ID and a data access level;
selecting a user access record associated with the received user ID and determine a corresponding data access level; and
generating the pharmacy data record as a function of the corresponding data access level associated with the selected user access record.

13. A method in accordance with claim 12, wherein the selected user pharmacy account record includes a plurality of data categories, the method further comprising:
selecting a group of data categories from the plurality of data categories as function of the corresponding data access level; and
generating the pharmacy data record including the selected data categories.

14. A method in accordance with claim 13, wherein the user-entity access list includes a plurality of data access levels including a first data access level associated with a first group of data categories and a second data access level associated with a second group of data categories.

15. A method in accordance with claim 14, wherein the first group of data categories includes information associated with a corresponding pharmaceutical drug and the second group of data categories includes information indicating customer refills associated with the corresponding pharmaceutical drug.

16. A method in accordance with claim 10, further comprising:
identifying a mobile computing device associated with the pharmacy customer as a function of the received user ID;
displaying an authorization request screen on the identified mobile computing device requesting the pharmacy customer to authorize the entity server system to receive pharmacy records associated with the pharmacy customer;
receiving, from the pharmacy customer via the mobile computing device, a request to authorize the entity server system to receive pharmacy records associated with the pharmacy customer; and
generating a user access record associated with the pharmacy customer including the received user ID and the received entity ID.

17. A method in accordance with claim 16, further comprising:
displaying an access level authorization screen including a list of data access levels in response to receiving the request to authorize the entity server system;
receiving a selection of a data access level from the pharmacy customer via the mobile computing device; and
generating the user access record including the selected data access level.

18. A method in accordance with claim 17, further comprising:
retrieving contact information associated with the received user ID;
transmitting a verification message to the pharmacy customer as a function of the retrieved contact information, the verification message including a hyperlink including verification data; and
generating the user access record upon receiving a signal indicating the hyperlink being accessed by the pharmacy customer.

19. One or more non-transitory computer-readable storage media, having computer-executable instructions embodied thereon, wherein when executed by at least one processor, the computer-executable instructions cause the processor to:
receive a request to transmit a pharmacy record to an entity server system, the request including an entity ID associated with the entity server system and a user ID associated with a pharmacy customer;
access a database including a list of user pharmacy account records and a list of authenticated entity records, each user pharmaceutical account record including a pharmacy user ID associated with a pharmacy customer and pharmaceutical drug information associated with corresponding prescription drug medications, each authenticated entity record including a unique entity ID and corresponding authentication data;
initiate a verification operation to verify an identity of the entity server system upon receiving the request to transmit a pharmacy record including accessing the list of authenticated entity records and determining an authenticated entity record having an entity ID matching the received entity ID;
access the list of user pharmacy account records upon verifying the identity of the entity server system and selecting a user pharmacy account record associated with the received user ID;
generate a pharmacy data record as a function of the selected user pharmacy account record; and
transmit the generated pharmacy data record to the entity server system.

20. One or more non-transitory computer-readable storage media in accordance with claim 19, wherein the computer-executable instructions cause the processor to:
access a user-entity access list including a plurality of user access records being stored in the database upon verifying the identity of the entity server system, each user access record including a user ID and a data access level;
select a user access record associated with the received user ID and determine a corresponding data access level; and
generate the pharmacy data record as a function of the corresponding data access level associated with the selected user access record.
